(19) United States
(12) Patent Application Publication
(10) Pub. No.: US 2025/0231054 A1
(43) Pub. Date: Jul. 17, 2025

(54) GEAR TRAIN MECHANICAL OPERATION EXPERIMENTAL INSTRUMENT

(71) Applicants: Institute of Geographic Sciences and Natural Resources Research, CAS, Beijing (CN); China University of Geosciences (Beijing), Beijing (CN)

(72) Inventors: Guilin Han, Beijing (CN); Qian Zhang, Beijing (CN); Tao Liang, Beijing (CN); Lingqing Wang, Beijing (CN)

(21) Appl. No.: 19/002,637

(22) Filed: Dec. 26, 2024

(30) Foreign Application Priority Data
Jan. 13, 2024 (CN) 202410091008.7

(51) Int. Cl. G01D 21/02; G01M 13/021

(52) U.S. Cl. CPC G01D 21/02; G01M 13/021

(57) ABSTRACT

A gear train mechanical operation experimental instrument is provided, which includes a detection table, a driving motor, an auxiliary gear, a support block, a second support column, a detection assembly, and a controller. The controller includes a driving control module, a data acquisition module, and an evaluation module. The controller makes a primary judgment on the quality of the gear to be detected, and a secondary judgment on whether there is friction abnormality in the gear to be detected. Based on the results of the primary judgment and the secondary judgment, the final judgment result is determined and displayed. The method of comprehensively considering multiple parameters helps to more accurately evaluate the status and quality of gears, not only allowing to perform evaluation on the real-time performance of the gear, but also detecting potential problems or abnormal situations, which helps to detect and solve problems early.

### CROSS-REFERENCE TO RELATED APPLICATIONS

This application claims to the benefit of priority from Chinese Application No. 202410091008.7 with a filing date of Jan. 23, 2024. The content of the aforementioned applications, including any intervening amendments thereto, are incorporated herein by reference.

### TECHNICAL FIELD

The present disclosure relates to the technical field of experimental instrument, in particular to a gear train mechanical operation experimental instrument.

### BACKGROUND

A gear is a mechanical component used to transmit power and motion, usually achieved through the meshing of the teeth of a gear with the teeth of other gears or mechanical parts. Gear systems are commonly used in various mechanical devices, such as automotive transmission systems, industrial machinery, and motors.

Gears must be precisely manufactured to ensure their normal operation, efficiency and safety of transmitting power of transmitting power. Gear qualification testing instrument is a kind of mechanical equipment used to test and evaluate the quality and performance of gears. These instruments play an important role in fields such as mechanical engineering, manufacturing, and automotive industry, ensuring the accuracy, reliability, and safety of gears.

In the process of gear operation, due to the need to mesh with other invisible teeth to work together, it is necessary to comprehensively consider multiple factors when inspecting the quality and safety of gears. Therefore, the present disclosure proposes a gear train mechanical operation experimental instrument, mainly to solve the problem of how to dynamically test the safety of gears during gear operation to improve the accuracy of gear inspection.

### SUMMARY

In view of this, the present disclosure provides a gear train mechanical operation experimental instrument, mainly to solve the problem of how to dynamically inspect the safety of gears during operation.

The present disclosure provides a gear train mechanical operation experimental instrument, which includes the following components:
a detection table, comprising a detection tabletop and a first support column, wherein the four corners of a lower surface of the detection tabletop are connected to one end of the first support column;
a driving motor, wherein the driving motor is installed below the detection tabletop, a driving end of the driving motor is connected to a driving shaft, and one end of the driving shaft passes through the detection tabletop;
an auxiliary gear, wherein the auxiliary gear is arranged at one end of the driving shaft passing through the detection table;
a support block, wherein the support block is arranged on an upper surface of the detection tabletop;
a second support column, wherein one end of the second support column is arranged on an upper surface of the support block, and an other end of the second support column is used to place the gear to be detected;
a detection assembly, comprising: a weight sensor, a first temperature sensor, a second temperature sensor, a vibration sensor, and a noise sensor, wherein the weight sensor is arranged inside the support block, the first temperature sensor is arranged inside the driving shaft, the second temperature sensor is arranged inside the second support column, the vibration sensor is arranged on the upper surface of the support block, and the noise sensor is arranged on the upper surface of the detection tabletop;
a controller, wherein the controller is arranged on the upper surface of the detection tabletop and electrically connected to the driving motor and detection component, and used to receive detection data from the detection component and control the driving motor;
the controller includes a driving control module, a data acquisition module and a evaluation module, wherein the driving control module is used to control an operation of the driving motor; the data acquisition module is used to obtain detection data of the detection assembly after the driving control module controls the operation of the driving motor, and the detection data include weight data, first temperature data, vibration data, noise data of the gear to be detected, and second temperature data of the auxiliary gear; the evaluation module is used to perform a primary judgment on a quality of the gear to be detected based on the weight data; when the primary judgment result is passed, a secondary judgment is performed on whether there is friction abnormality in the gear to be detected based on the first temperature data and the second temperature data; a final judgment result is determined and displayed based on the primary judgment result and the secondary judgment result.

In some embodiments of the present application, the weight data is a weight value of the gear to be detected, the first temperature data is a real-time temperature value of the auxiliary gear when the driving motor is running, the second temperature data is a real-time temperature value of the gear to be detected when the driving motor is running, the vibration data is a real-time vibration intensity value of the gear to be detected when the driving motor is running, and the noise data is a real-time sound wave amplitude value of the gear to be detected when the driving motor is running.

In some embodiments of the present application, the evaluation module is used to perform the primary judgment on whether the quality of the gear to be detected is qualified based on the weight data, including:
obtaining weight data A0 of the gear to be detected;
presetting a maximum weight threshold Amax and a minimum weight threshold Amin for the gear to be detected through the evaluation module;
when Amax≥A0≥Amin, the primary judgment result of the evaluation module is determined to be passed, and a secondary judgment is performed;
when Amax<A0 or A0<Amin, the primary judgment result of the evaluation module is determined to be not passed, and the final judgment result is determined to be not passed.

In some embodiments of the present application, a process of performing a secondary judgment when the primary judgment result of the evaluation module is passed includes: obtaining the second temperature data B0 of the gear to be detected;
presetting a second temperature maximum threshold Bmax and a second temperature minimum threshold Bmin for the gear to be detected through the evaluation module;
when Bmax≥B0≥Bmin, the secondary judgment result of the evaluation module is determined to be passed, and a first verification judgment is performed;
when Bmax<B0 or B0<Bmin, the secondary judgment result of the evaluation module is determined to be not passed, and the final judgment result is determined to be not passed.

In some embodiments of the present application, a process of performing a first verification judgment when the secondary judgment result of the evaluation module is passed includes:
obtaining the first temperature data C0 of the auxiliary gear;
calculating the temperature difference ΔB by subtracting the second temperature data B0 of the gear to be detected from the first temperature data C0 of the auxiliary gear, where Δ B=|B0−C0|;
presetting, through the evaluation module, a maximum temperature difference threshold Ba, Ba>0;
when ΔB>Ba, the first verification judgment result of the evaluation module is to correct the secondary judgment result, and the corrected secondary judgment result is not passed;
when Δ B≤Ba, the first verification judgment result of the evaluation module is not to correct the secondary judgment result.

In some embodiments of the present application, a process that after the evaluation module determines that the secondary judgment result is passed further includes:
presetting the second verification judgment coefficient D0, and D0=1;
obtaining the real-time vibration intensity value E0 of the gear to be detected;
presetting a first preset vibration intensity threshold E1, a second preset vibration intensity threshold E2, a third preset vibration intensity threshold E3, and a fourth preset vibration intensity threshold E4 for the gear to be detected, and E1>E2>E3>E4; presetting a first preset adjustment coefficient e1, a second preset adjustment coefficient e2, a third preset adjustment coefficient e3, and a fourth preset adjustment coefficient e4, and 0<e1<e2<0.5<e3<e4<1;
when E0>E1, selecting the first preset adjustment coefficient e1 to adjust the second verification judgment coefficient D0, and the adjusted second verification judgment coefficient is D0*e1;
when E1>E0>E2, selecting the second preset adjustment coefficient e2 to adjust the second verification judgment coefficient D0, and the adjusted second verification judgment coefficient is D0*e2;
when E2>E0≥E3, selecting the third preset adjustment coefficient e3 to adjust the second verification judgment coefficient D0, and the adjusted second verification judgment coefficient is D0*e3;
when E3>E0≥E4, selecting the fourth preset adjustment coefficient e4 to adjust the second verification judgment coefficient D0, and the adjusted second verification judgment coefficient is D0*e4.

In some embodiments of the present application, the evaluation module adjusts the second verification judgment coefficient D0 by selecting the i-th preset adjustment coefficient ei, where i=1, 2, 3, 4, after obtaining the adjusted second verification judgment coefficient D0*ei, it further includes:
obtaining the real-time sound wave amplitude value F0 of the gear to be detected;
presetting a first preset sound wave amplitude threshold F1, a second preset sound wave amplitude threshold F2, a third preset sound wave amplitude threshold F3, and a fourth preset sound wave amplitude threshold F4 for the gear to be detected, and F1>F2>F3>F4; presetting a first preset adjustment coefficient f1, a second preset adjustment coefficient f2, a third preset adjustment coefficient f3, and a fourth preset adjustment coefficient f4, and 0<f1<f2<0.5<f3<f4<1;
when F0≥F1, selecting the first preset adjustment coefficient f1 to perform a second adjustment on the adjusted second verification judgment coefficient D0*ei, and the second verification judgment coefficient after the second adjustment is D0*ei*f1;
when F1>F0≥F2, selecting the second preset adjustment coefficient f2 to perform a second adjustment on the adjusted second verification judgment coefficient D0*ei, and the second verification judgment coefficient after the second adjustment is D0*ei*f2;
when F2>F0≥F3, selecting the third preset adjustment coefficient f3 to perform a second adjustment on the adjusted second verification judgment coefficient D0*ei, and the second verification judgment coefficient after the second adjustment is D0*ei*f3;
when F3>F0≥F4, selecting the fourth preset adjustment coefficient f4 to perform a second adjustment on the adjusted second verification judgment coefficient D0*ei, and the second verification judgment coefficient after the second adjustment is D0*ei*f4.

In some embodiments of the present application, the evaluation module selects the i-th preset adjustment coefficient fi to perform a second adjustment on the adjusted second verification judgment coefficient D0*ei, where i=1, 2, 3, 4, after obtaining the adjusted second verification judgment coefficient D0*ei*fi after second adjustment, it further includes:
taking the second verification judgment coefficient D0*ei*fi after second adjustment as the second verification judgment adjustment coefficient Da;
the evaluation module is also used to record a real-time running time t of the gear to be detected and an initial temperature value T of the gear to be detected at a beginning of operation;
calculating a real-time temperature change rate ΔT=(B0−T)/t of the gear to be detected based on the second temperature data B0 of the gear to be detected;
presetting the maximum threshold Tmax for the real-time temperature change rate of the gear to be detected;
when ΔT>Tmax, the evaluation module determines to correct the second verification judgment adjustment coefficient Da;
when ΔT≤Tmax, the evaluation module determines to correct the second verification judgment adjustment coefficient Da.

In some embodiments of the present application, a process that the evaluation module determines to correct the second verification judgment adjustment coefficient Da includes:
presetting a first preset real-time temperature change rate threshold T1, a second preset real-time temperature change rate threshold T2, a third preset real-time temperature change rate threshold T3, and a fourth preset real-time temperature change rate threshold T4, and T1>T2>T3>T4=Tmax; presetting a first preset adjustment coefficient t1, a second preset adjustment coefficient t2, a third preset adjustment coefficient t3, and a fourth preset adjustment coefficient t4, and 0<t1<t2<t3<t4<1;
when ΔT>T1, selecting the first preset adjustment coefficient tl to correct the second verification judgment adjustment coefficient Da, and the corrected second verification judgment adjustment coefficient is Da*t1;
when T1≥ΔT>T2, selecting the second preset adjustment coefficient t2 to correct the second verification judgment adjustment coefficient Da, and the corrected second verification judgment adjustment coefficient is Da*t2;
when T2≥ΔT>T3, selecting the third preset adjustment coefficient t3 to correct the second verification judgment adjustment coefficient Da, and the corrected second verification judgment adjustment coefficient is Da*t3;
when T3≥ΔT>T4, selecting the fourth preset adjustment coefficient t4 to correct the second verification judgment adjustment coefficient Da, and the corrected second verification judgment adjustment coefficient is Da*t4.

In some embodiments of the present application, the evaluation module selects the i-th preset adjustment coefficient ti to correct the second verification judgment adjustment coefficient Da, where i=1, 2, 3, 4, after obtaining the corrected second verification judgment adjustment coefficient Da*ti, further includes:
taking the corrected second verification judgment adjustment coefficient Da*ti as the second verification judgment final coefficient Db;
presetting the second verification judgment maximum threshold Dmax;
when Db>Dmax, the evaluation module determines that the second verification judgment result is to correct the secondary judgment result, and the corrected secondary judgment result is not passed, so that the final judgment result is not passed;
when Db≤Dmax, the evaluation module determines that the second verification judgment result is not corrected, so that the secondary judgment result is the final judgment result;
displaying the results based on the final judgment.

Compared with the existing technology, the present disclosure has the following advantageous effects: according to the present disclosure, firstly, by collecting multiple detection data related to the gear, including weight data, first temperature data, vibration data, noise data of the gear to be detected, and second temperature data of the auxiliary gear, then the evaluation module evaluates and judges the gear to be detected, which is divided into two stages: The primary judgment, based on the weight data, the quality of the gear is evaluated; if the primary judgment result is passed, that is, the gear quality is qualified, it enters the next stage, the secondary judgment. After passing the primary judgment, the first temperature data and the second temperature data are used to detect whether there is friction abnormality in the gear. This can help identify potential issues or abnormal operating conditions. Finally, based on the results of the primary judgment and the secondary judgment, the system determines the final judgment result of the gear and displays this result for further analysis and decision-making.

### BRIEF DESCRIPTION OF THE DRAWINGS

By reading the detailed description of the preferred embodiments in the following text, various other advantages and benefits will become clear to those skilled in the art. The accompanying drawings are only for the purpose of illustrating preferred embodiments and are not to be considered as limitations of the present disclosure. In the accompanying drawings:

FIG. 1 is a schematic structure diagram of a gear train mechanical operation experimental instrument provided in an embodiment of the present disclosure;

FIG. 2 is a functional block diagram of a controller provided in an embodiment of the present disclosure.

Reference numbers in the drawings: 1. detection tabletop; 2. first support column; 3. driving motor; 4. driving shaft; 5. auxiliary gear; 6. support block; 7. second support column; 8. weight sensor; 9. first temperature sensor; 10. second temperature sensor; 11. vibration sensor; 12. noise sensor; 13. controller; 14. gear to be detected.

### DETAILED DESCRIPTION OF THE EMBODIMENTS

The exemplary embodiments of the present disclosure will be described in more detail below with reference to the accompanying drawings. Although exemplary embodiments of the present disclosure are shown in the accompanying drawings, it should be understood that the present disclosure may be implemented in various forms and should not be limited by the embodiments described herein. On the contrary, these embodiments are provided to enable a more thorough understanding of this disclosure and to fully convey the scope of this disclosure to those skilled in the art. It should be noted that the embodiments and features in the embodiments of the present disclosure can be combined with each other without conflict. The present disclosure will be described in detail below with reference to the accompanying drawings and in conjunction with embodiments.

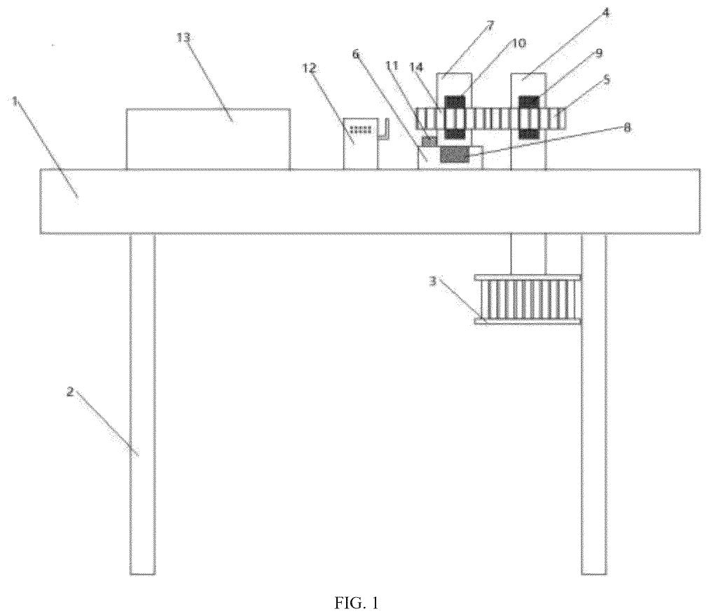

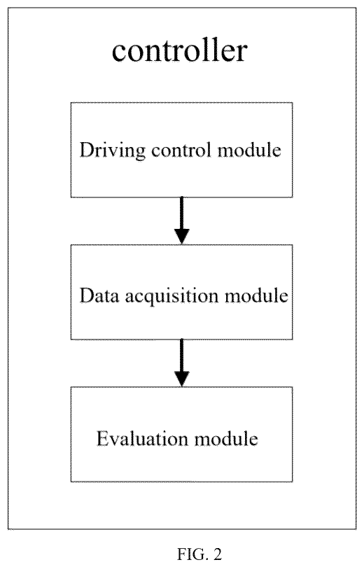

Referring to FIG. 1 and FIG. 2, this embodiment provides a gear train mechanical operation experimental instrument, which includes a detection table, a driving motor, an auxiliary gear, a support block, a second support column, a detection assembly, and a controller.

The detection table includes a detection tabletop 1 and a first support column 2, and the four corners of the lower surface of the detection tabletop 1 are connected to one end of the first support column 2.

The driving motor 3 is arranged below the detection tabletop 1, the driving end of the driving motor 3 is connected to a driving shaft 4, and one end of driving shaft 4 passes through the detection tabletop 1.

An auxiliary gear 5 is arranged at one end of the driving shaft 4 passing through the detection tabletop.

A support block 6 is arranged on the upper surface of the detection tabletop 1.

In the second support column 7, one end of the second support column 7 is arranged on the upper surface of the support block 6, and the other end of the second support column 7 is used to place the gear to be detected 14.

The detection assembly includes: a weight sensor 8, a first temperature sensor 9, a second temperature sensor 10, a vibration sensor 11, and a noise sensor 12. The weight sensor 8 is arranged inside the support block 6, the first temperature sensor 9 is arranged inside the driving shaft 4, the second temperature sensor 10 is arranged inside the second support column 7, the vibration sensor 11 is arranged on the upper surface of the support block 6, and the noise sensor 12 is arranged on the upper surface of the detection tabletop 1.

A controller 13 is arranged on the upper surface of the detection tabletop 1 and electrically connected to the driving motor 3 and the detection assembly, and is used to receive detection data from the detection assembly and control the driving motor 3.

The controller includes a driving control module, a data acquisition module and a evaluation module. The driving control module is used to control the operation of the driving motor 3; the data acquisition module is used to obtain detection data of the detection assembly after the driving control module controls the operation of the driving motor, wherein the detection data includes the weight data, the first temperature data, the vibration data, the noise data, of the gear to be detected 14, and the second temperature data of the auxiliary gear; the evaluation module is used to perform a primary judgment on the quality of the gear to be detected 14 based on the weight data. When the primary judgment result is passed, a secondary judgment is performed on whether there is friction abnormality in the gear to be detected 14 based on the first temperature data and the second temperature data. The final judgment result is determined and displayed based on the primary judgment result and the secondary judgment result.

Specifically, in this embodiment, an auxiliary gear 5 is arranged at one end of the driving shaft 4, and a gear to be detected 14 is arranged at the other end of the second support column 7, and the gear to be detected 14 meshes with the auxiliary gear 5. The auxiliary gear 5 and the gear to be detected 14 are synchronously rotated and operated by the driving motor 3 for testing.

It can be understood that in this embodiment, after the operation of the driving motor 3, the data of the detection assembly is obtained, including the weight data, the first temperature data, the vibration data, the noise data of the gear to be detected 14, and the second temperature data of the auxiliary gear 5. Based on the weight data, the primary judgment is performed on the quality of the gear to be detected 14. If the primary judgment is passed, the secondary judgment is performed to determine whether there is a friction abnormality of the gear to be detected 14 based on the first temperature data and the second temperature data. The final judgment result is determined based on the results of the primary judgment and the secondary judgment, then displaying the final judgment result, achieving accurate inspection of the safety and stability of the gear operation process to ensure the quality and performance of the gear.

In a specific embodiment of the present application, the weight data is the weight value of the gear to be detected 14, the first temperature data is the real-time temperature value of the auxiliary gear 5 after the driving motor 3 is running, the second temperature data is the real-time temperature value of the gear to be detected 14 after the driving motor 3 is running, the vibration data is the real-time vibration intensity value of the gear to be detected 14 after the driving motor 3 is running, and the noise data is the real-time sound wave amplitude value of the gear to be detected 14 after the driving motor 3 is running.

In a specific embodiment of the present application, the evaluation module is used to perform the primary judgment on whether the quality of the gear to be detected 14 is qualified based on the weight data, including:

Obtaining weight data A0 of the gear to be detected 14;

Presetting, through the evaluation module, the maximum weight threshold Amax and the minimum weight threshold Amin for the gear to be detected 14;

When Amax≥A0≥Amin, the primary judgment result of the evaluation module is determined to be passed, and a secondary judgment is performed;

When Amax<A0 or A0<Amin, the primary judgment result of the evaluation module is determined to be not passed, and the final judgment result is determined to be not passed.

It can be understood that in this embodiment, the weight data A0 of the gear to be detected 14 is obtained, and the evaluation module presets two thresholds: the highest threshold Amax represents the maximum allowable value of the gear weight, and the lowest threshold Amin represents the minimum allowable value of the gear weight. If Amax ≥ A0≥Amin, the primary judgment result of the evaluation module is passed. After passing the primary judgment, further evaluation or detecting can be carried out. If Amax<A0 or A0<Amin, the primary judgment result of the evaluation module is not passed. If the primary judgment result is not passed, the final judgment result is also not passed, which means that the weight of the gear does not meet the preset threshold range, further processing or inspection may be necessary. The first verification judgment mechanism in this embodiment is beneficial for gear quality control, helping to ensure that the produced gears meet quality standards and reduce the risk of defects or non-conforming products that may occur during production. In addition, the passing of the primary judgment provides further opportunities for detection and analysis for subsequent secondary judgment, which helps to more comprehensively evaluate the performance of gears.

In a specific embodiment of the present application, the process of performing a secondary judgment when the primary judgment result of the evaluation module is passed, including:

Obtaining the second temperature data B0 of the gear to be detected 14;

Presetting, through the evaluation module, the second temperature maximum threshold Bmax and the second temperature minimum threshold Bmin for the gear to be detected 14;

When Bmax≥B0≥Bmin, the secondary judgment result of the evaluation module is determined to be passed, and a first verification judgment is performed;

When Bmax<B0 or B0<Bmin, the secondary judgment result of the evaluation module is determined to be not passed, and the final judgment result is determined to be not passed.

It can be understood that in this embodiment, the second temperature data B0 of the gear to be detected 14 is obtained, the evaluation module presets two second temperature thresholds. If Bmax≥B0≥Bmin, the secondary judgment result of the evaluation module is passed. After passing the secondary judgment, further verification or detection can be carried out. If Bmax<B0 or B0<Bmin, the secondary judgment result of the evaluation module is not passed. If the secondary judgment result is not passed, the final judgment result is also not passed. This indicates that the second temperature of the gear does not meet the preset threshold range and may need further processing or inspection, which helps to ensure that the temperature of the gear during operation is within a safe and reasonable range. At the same time, potential issues such as abnormal friction during gear operation are detected in advance. The passing of the secondary judgment also provides an opportunity for the subsequent first verification judgment to further verify the performance and quality of the gear, which helps to improve the reliability and safety of the gear.

In a specific embodiment of the present application, the process of performing a first verification judgment when the secondary judgment result of the evaluation module is passed, including:

Obtaining the first temperature data C0 of the auxiliary gear 5;

Calculating the temperature difference ΔB by subtracting the second temperature data B0 of the gear to be detected 14 from the first temperature data C0 of the auxiliary gear 5, where Δ B=|B0−C0|;

Presetting, through the evaluation module, a maximum temperature difference threshold Ba, Ba>0;

When ΔB>Ba, the first verification judgment result of the evaluation module is to correct the secondary judgment result, and the corrected secondary judgment result is not passed;

When Δ B≤Ba, the first verification judgment result of the evaluation module is not to correct the secondary judgment result.

It can be understood that in this embodiment, important information about the gear temperature can be obtained by calculating the difference between the second temperature data B0 of the gear to be detected 14 and the first temperature data C0 of the auxiliary gear 5, that is, the temperature difference ΔB. The temperature change of the gear can be monitored through the temperature difference ΔB, and potential temperature anomalies can be detected. If the temperature difference is too large, there is an abnormal problem. If the temperature difference is small, it indicates that the safety risk of gear operation is small. At the same time, if the temperature difference ΔB is greater than the maximum temperature difference threshold Ba, the evaluation module will correct the secondary judgment result and set the corrected result as no pass. This indicates that although the secondary judgement may pass, a final judgement of no pass is still required for the gear due to the abnormal temperature difference. By monitoring the temperature difference, the system can detect potential temperature anomalies, thereby improving the safety and reliability of gears. Correcting the secondary judgment result can also help reduce problems that may be caused by temperature anomalies and ensure that gears meet quality standards.

In a specific embodiment of the application, after the evaluation module determines that the secondary judgment result is passed, it further includes the following steps: Presetting the second verification judgment coefficient D0, and D0=1;

Obtaining the real-time vibration intensity value E0 of the gear to be detected 14;

Presetting the first preset vibration intensity threshold E1, the second preset vibration intensity threshold E2, the third preset vibration intensity threshold E3, and the fourth preset vibration intensity threshold E4 for the gear to be detected 14, and E1>E2>E3>E4; presetting the first preset adjustment coefficient e1, the second preset adjustment coefficient e2, the third preset adjustment coefficient e3, and the fourth preset adjustment coefficient e4, and 0<e1<e2<0.5<e3<e4<1;

When E0≥E1, selecting the first preset adjustment coefficient e1 to adjust the second verification judgment coefficient D0, and the adjusted second verification judgment coefficient is D0*e1;

When E1>E0≥E2, selecting the second preset adjustment coefficient e2 to adjust the second verification judgment coefficient D0, and the adjusted second verification judgment coefficient is D0*e2;

When E2>E0≥E3, selecting the third preset adjustment coefficient e3 to adjust the second verification judgment coefficient D0, and the adjusted second verification judgment coefficient is D0*e3;

When E3>E0≥E4, selecting the fourth preset adjustment coefficient e4 to adjust the second verification judgment coefficient D0, and the adjusted second verification judgment coefficient is D0*e4.

In a specific embodiment of the present application, the evaluation module adjusts the second verification judgment coefficient D0 by selecting the i-th preset adjustment coefficient ei, where i=1, 2, 3, 4. After obtaining the adjusted second verification judgment coefficient D0*ei, it further includes the following steps:

Obtaining the real-time sound wave amplitude value F0 of the gear to be detected 14;

Presetting the first preset sound wave amplitude threshold F1, the second preset sound wave amplitude threshold F2, the third preset sound wave amplitude threshold F3, and the fourth preset sound wave amplitude threshold F4 for the gear to be detected 14, and F1>F2>F3>F4; presetting the first preset adjustment coefficient f1, the second preset adjustment coefficient f2, the third preset adjustment coefficient f3, and the fourth preset adjustment coefficient f4, and 0<f1<f2<0.5<f3<f4<1;

When F0≥F1, selecting the first preset adjustment coefficient f1 to perform a second adjustment on the adjusted second verification judgment coefficient D0*ei, and the second verification judgment coefficient after the second adjustment is D0*ei*f1;

When F1>F0≥F2, selecting the second preset adjustment coefficient f2 to perform a second adjustment on the adjusted second verification judgment coefficient D0*ei, and the second verification judgment coefficient after the second adjustment is D0*ei*f2;

When F2>F0≥F3, selecting the third preset adjustment coefficient f3 to perform a second adjustment on the adjusted second verification judgment coefficient D0*ei, and the second verification judgment coefficient after the second adjustment is D0*ei*f3;

When F3>F0≥F4, selecting the fourth preset adjustment coefficient f4 to perform a second adjustment on the adjusted second verification judgment coefficient D0*ei, and the second verification judgment coefficient after the second adjustment is D0*ei*f4.

It can be understood that in this embodiment, by dynamically adjusting the second verification judgment coefficient D0 based on real-time data, different parameters will trigger different adjustment coefficients to make corrections according to the actual situation. By using multiple parameters and dynamically adjusting the second verification judgment coefficient, the system can more accurately evaluate the status of the gear, not only focusing on vibration intensity but also considering sound wave amplitude. This can help to detect and solve potential faults before the problem worsens, improves detection accuracy, reduces the possibility of misjudgment, and ensures the quality and performance of the gear. Meanwhile, due to the adoption of a dynamic adjustment mechanism, the system can reduce false alarm and missing alarm, improving the accuracy of detection.

In a specific embodiment of the present application, the evaluation module selects the i-th preset adjustment coefficient fi to perform a second adjustment on the adjusted second verification judgment coefficient D0*ei, where i=1, 2, 3, 4. After obtaining the adjusted second verification judgment coefficient D0*ei*fi after second adjustment, it further includes the following steps:

Taking the second verification judgment coefficient D0*ei*fi after second adjustment as the second verification judgment adjustment coefficient Da;

The evaluation module is also used to record the real-time running time t of the gear to be detected 14 and the initial temperature value T of the gear to be detected 14 at the beginning of operation;

Calculating the real-time temperature change rate Δ T=(B0−T)/t of the gear to be detected 14 based on the second temperature data B0 of the gear to be detected 14;

Presetting the maximum threshold Tmax for the real-time temperature change rate of the gear to be detected 14;

When ΔT>Tmax, the evaluation module determines to correct the second verification judgment adjustment coefficient Da;

When ΔT≤Tmax, the evaluation module determines to correct the second verification judgment adjustment coefficient Da.

In a specific embodiment of the present application, the process that the evaluation module determines to correct the second verification judgment adjustment coefficient Da, it includes:

Presetting the first preset real-time temperature change rate threshold T1, the second preset real-time temperature change rate threshold T2, the third preset real-time temperature change rate threshold T3, and the fourth preset real-time temperature change rate threshold T4, and T1>T2>T3>T4=Tmax; presetting the first preset adjustment coefficient t1, the second preset adjustment coefficient t2, the third preset adjustment coefficient t3, and the fourth preset adjustment coefficient t4, and 0<t1<t2<t3<t4<1;

When ΔT>T1, selecting the first preset adjustment coefficient tl to correct the second verification judgment adjustment coefficient Da, and the corrected second verification judgment adjustment coefficient is Da*t1;

When T1≤ΔT>T2, selecting the second preset adjustment coefficient t2 to correct the second verification judgment adjustment coefficient Da, and the corrected second verification judgment adjustment coefficient is Da*t2;

When T2≥ΔT>T3, selecting the third preset adjustment coefficient t3 to correct the second verification judgment adjustment coefficient Da, and the corrected second verification judgment adjustment coefficient is Da*t3;

When T3≥ΔT>T4, selecting the fourth preset adjustment coefficient t4 to correct the second verification judgment adjustment coefficient Da, and the corrected second verification judgment adjustment coefficient is Da*t4.

In a specific embodiment of the present application, the evaluation module selects the i-th preset adjustment coefficient ti to correct the second verification judgment adjustment coefficient Da, where i=1, 2, 3, 4. After obtaining the corrected second verification judgment adjustment coefficient Da*ti, the evaluation module further includes the following steps:

Taking the corrected second verification judgment adjustment coefficient Da*ti as the second verification judgment final coefficient Db;

Presetting the second verification judgment maximum threshold Dmax;

When Db>Dmax, the evaluation module determines that the second verification judgment result is to correct the secondary judgment result, and the corrected secondary judgment result is not passed, that is, the final judgment result is not passed;

When Db≤Dmax, the evaluation module determines that the second verification judgment result will not be corrected, that is, the secondary judgment result is the final judgment result;

Displaying the results based on the final judgment.

It can be understood that in this embodiment, the second verification judgment coefficient is dynamically adjusted based on real-time data and multiple parameters, including vibration intensity, sound wave amplitude, temperature change rate, etc. The method of comprehensively considering multiple parameters helps to more accurately evaluate the status and quality of the gear. It not only allows for the evaluation of the real-time performance of the gear, but also allows for the detection of potential problems or abnormal situations, such as abnormal vibration intensity, abnormal sound wave amplitude, or abnormal temperature change rate, which helps to detect and solve problems early. The adaptability of the system enables it to be adjusted and corrected according to different situations and parameter changes, which helps to meet the gear detection needs under different operating conditions, improves the adaptability of the system, and is displayed through the final judgment results. This mechanism ensures that the quality and performance of the gears are effectively controlled and monitored, allowing operators to understand the status of the gears and whether further processing is needed.

It should be understood by those skilled in the art that the embodiments of the present application can be provided as methods, systems, or computer program products. Therefore, the present application may take the form of a fully hardware embodiment, a fully software embodiment, or a combination of software and hardware embodiment. Moreover, the present application may take the form of a computer program product implemented on one or more computer usable storage media (including but not limited to disk storage, CD-ROM, optical storage, etc.) containing computer usable program codes.

This application is described with reference to the method, the device (system), and the flowchart and/or block diagram of the computer program product according to the embodiments of this application. It should be understood that each process and/or square frame in the flowchart and/or block diagram, as well as the combination of processes and/or blocks in the flowchart and/or block diagram, can be implemented by computer program instructions. These computer program instructions can be provided to a processor of a general-purpose computer, a specialized computer, an embedded processor, or other programmable data processing device to generate a machine, such that the instructions executed by the processor of the computer or other programmable data processing device generate a device for implementing the functions specified in one or more processes in the flowchart and/or one or more square frames in the block diagram.

These computer program instructions can also be stored in computer-readable memory that can guide a computer or other programmable data processing device to operate in a specific manner, causing the instructions stored in the computer-readable memory to produce a manufactured product including instruction devices that implement the functions specified in one process or more processes in the flowchart and/or one or more square frames in block diagram.

These computer program instructions can also be loaded onto a computer or other programmable data processing device, enabling a series of operational steps to be executed on the computer or other programmable device to generate computer implemented processing. The instructions executed on the computer or other programmable device provide steps for implementing the functions specified in one process or more processes in the flowchart and/or one or more square frames in block diagram.

Finally, it should be noted that the above embodiments are only used to illustrate the technical solution of the present disclosure and not to limit it. Although the present disclosure has been described in detail with reference to the above embodiments, those skilled in the art should understand that modifications or equivalent substitutions can still be made to the specific embodiments of the present disclosure, and any modifications or equivalent substitutions that do not depart from the spirit and scope of the present disclosure should be covered within the scope of protection of the claims of the present disclosure.

1. A gear train mechanical operation experimental instrument, comprising:
a detection table, comprising a detection tabletop and a first support column, wherein the four corners of a lower surface of the detection tabletop are connected to one end of the first support column;
a driving motor, wherein the driving motor is installed below the detection tabletop, a driving end of the driving motor is connected to a driving shaft, and one end of the driving shaft passes through the detection tabletop;
an auxiliary gear, wherein the auxiliary gear is arranged at one end of the driving shaft passing through the detection table;
a support block, wherein the support block is arranged on an upper surface of the detection tabletop;
a second support column, wherein one end of the second support column is arranged on an upper surface of the support block, and an other end of the second support column is used to place the gear to be detected;
a detection assembly, comprising a weight sensor, a first temperature sensor, a second temperature sensor, a vibration sensor, and a noise sensor, wherein the weight sensor is arranged inside the support block, the first temperature sensor is arranged inside the driving shaft, the second temperature sensor is arranged inside the second support column, the vibration sensor is arranged on the upper surface of the support block, and the noise sensor is arranged on the upper surface of the detection tabletop;
a controller, wherein the controller is arranged on the upper surface of the detection tabletop and electrically connected to the driving motor and detection component, and used to receive detection data from the detection component and control the driving motor;
the controller comprises a driving control module, wherein the driving control module is used to control an operation of the driving motor.

2. The gear train mechanical operation experimental instrument according to claim 1, wherein the controller further comprises a data acquisition module, the data acquisition module is used to obtain detection data of the detection assembly after the driving control module controls the operation of the driving motor, and the detection data comprise weight data, first temperature data, vibration data, noise data of the gear to be detected, and second temperature data of the auxiliary gear;
the weight data is a weight value of the gear to be detected, the first temperature data is a real-time temperature value of the auxiliary gear when the driving motor is running, the second temperature data is a real-time temperature value of the gear to be detected when the driving motor is running, the vibration data is a real-time vibration intensity value of the gear to be detected when the driving motor is running, and the noise data is a real-time sound wave amplitude value of the gear to be detected when the driving motor is running.

3. The gear train mechanical operation experimental instrument according to claim 1, wherein the controller further comprises an valuation module, the evaluation module is used to perform a primary judgment on a quality of the gear to be detected based on the weight data; when the primary judgment result is passed, a secondary judgment is performed on whether there is friction abnormality in the gear to be detected based on the first temperature data and the second temperature data; a final judgment result is determined and displayed based on the primary judgment result and the secondary judgment result;
the evaluation module is used to perform the primary judgment on whether the quality of the gear to be detected is qualified based on the weight data, comprising the following steps:
obtaining weight data A0 of the gear to be detected;
presetting a maximum weight threshold Amax and a minimum weight threshold Amin for the gear to be detected through the evaluation module;
when Amax≥A0≥Amin, the primary judgment result of the evaluation module is determined to be passed, and a secondary judgment is performed;
when Amax<A0 or A0<Amin, the primary judgment result of the evaluation module is determined to be not passed, and the final judgment result is determined to be not passed;
a process of performing a secondary judgment when the primary judgment result of the evaluation module is passed comprises:
obtaining the second temperature data B0 of the gear to be detected;
presetting a second temperature maximum threshold Bmax and a second temperature minimum threshold Bmin for the gear to be detected through the evaluation module;
when Bmax≥B0≥Bmin, the secondary judgment result of the evaluation module is determined to be passed, and a first verification judgment is performed;
when Bmax<B0 or B0<Bmin, the secondary judgment result of the evaluation module is determined to be not passed, and the final judgment result is determined to be not passed;
a process of performing a first verification judgment when the secondary judgment result of the evaluation module is passed comprises:
obtaining the first temperature data C0 of the auxiliary gear;
calculating the temperature difference ΔB by subtracting the second temperature data B0 of the gear to be detected from the first temperature data C0 of the auxiliary gear, where Δ B=|B0−C0|;
presetting, through the evaluation module, a maximum temperature difference threshold Ba, Ba>0;
when ΔB>Ba, the first verification judgment result of the evaluation module is to correct the secondary judgment result, and the corrected secondary judgment result is not passed;
when Δ B≤Ba, the first verification judgment result of the evaluation module is not to correct the secondary judgment result.

4. The gear train mechanical operation experimental instrument according to claim 3, wherein a process that after the evaluation module determines that the secondary judgment result is passed further comprises:
presetting the second verification judgment coefficient D0, and D0=1;
obtaining the real-time vibration intensity value E0 of the gear to be detected;
presetting a first preset vibration intensity threshold E1, a second preset vibration intensity threshold E2, a third preset vibration intensity threshold E3, and a fourth preset vibration intensity threshold E4 for the gear to be detected, and E1>E2>E3>E4; presetting a first preset vibration intensity adjustment coefficient e1, a second preset vibration intensity adjustment coefficient e2, a third preset vibration intensity adjustment coefficient e3, and a fourth preset vibration intensity adjustment coefficient e4, and 0<e1<e2<0.5<e3<e4<1;
when E0≥E1, selecting the first preset adjustment coefficient e1 to adjust the second verification judgment coefficient D0, and the adjusted second verification judgment coefficient is D0*e1;
when E1>E0≥E2, selecting the second preset adjustment coefficient e2 to adjust the second verification judgment coefficient D0, and the adjusted second verification judgment coefficient is D0*e2;
when E2>E0≥E3, selecting the third preset adjustment coefficient e3 to adjust the second verification judgment coefficient D0, and the adjusted second verification judgment coefficient is D0*e3;
when E3>E0≥E4, selecting the fourth preset adjustment coefficient e4 to adjust the second verification judgment coefficient D0, and the adjusted second verification judgment coefficient is D0*e4.

5. The gear train mechanical operation experimental instrument according to claim 4, wherein the evaluation module adjusts the second verification judgment coefficient D0 by selecting the i-th preset adjustment coefficient ei, where i=1, 2, 3, 4, after obtaining the adjusted second verification judgment coefficient D0*ei, it further comprises:
obtaining the real-time sound wave amplitude value F0 of the gear to be detected;
presetting a first preset sound wave amplitude threshold F1, a second preset sound wave amplitude threshold F2, a third preset sound wave amplitude threshold F3, and a fourth preset sound wave amplitude threshold F4 for the gear to be detected, and F1>F2>F3>F4; presetting a first preset sound wave amplitude adjustment coefficient f1, a second preset sound wave amplitude adjustment coefficient f2, a third preset sound wave amplitude adjustment coefficient f3, and a fourth preset sound wave amplitude adjustment coefficient f4, and 0<f1<f2<0.5<f3<f4<1;
when F0≥F1, selecting the first preset adjustment coefficient f1 to perform a second adjustment on the adjusted second verification judgment coefficient D0*ei, and the second verification judgment coefficient after the second adjustment is D0*ei*f1;
when F1>F0≥F2, selecting the second preset adjustment coefficient f2 to perform a second adjustment on the adjusted second verification judgment coefficient D0*ei, and the second verification judgment coefficient after the second adjustment is D0*ei*f2;
when F2>F0≥F3, selecting the third preset adjustment coefficient f3 to perform a second adjustment on the adjusted second verification judgment coefficient D0*ei, and the second verification judgment coefficient after the second adjustment is D0*ei*f3;
when F3>F0≥F4, selecting the fourth preset adjustment coefficient f4 to perform a second adjustment on the adjusted second verification judgment coefficient D0*ei, and the second verification judgment coefficient after the second adjustment is D0*ei*f4.

6. The gear train mechanical operation experimental instrument according to claim 5, wherein the evaluation module selects the i-th preset adjustment coefficient fi to perform a second adjustment on the adjusted second verification judgment coefficient D0*ei, where i=1, 2, 3, 4, after obtaining the adjusted second verification judgment coefficient D0*ei*fi after second adjustment, it further comprises:
taking the second verification judgment coefficient D0*ei*fi after second adjustment as the second verification judgment adjustment coefficient Da;
the evaluation module is also used to record a real-time running time t of the gear to be detected and an initial temperature value T of the gear to be detected at a beginning of operation;
calculating a real-time temperature change rate Δ T=(B0−T)/t of the gear to be detected based on the second temperature data B0 of the gear to be detected;
presetting the maximum threshold Tmax for the real-time temperature change rate of the gear to be detected;
when ΔT>Tmax, the evaluation module determines to correct the second verification judgment adjustment coefficient Da;
when ΔT≤Tmax, the evaluation module determines to correct the second verification judgment adjustment coefficient Da.

7. The gear train mechanical operation experimental instrument according to claim 6, wherein a process that the evaluation module determines to correct the second verification judgment adjustment coefficient Da comprises:
presetting a first preset real-time temperature change rate threshold T1, a second preset real-time temperature change rate threshold T2, a third preset real-time temperature change rate threshold T3, and a fourth preset real-time temperature change rate threshold T4, and T1>T2>T3>T4=Tmax; presetting a first preset temperature adjustment coefficient t1, a second preset temperature adjustment coefficient t2, a third preset temperature adjustment coefficient t3, and a fourth preset temperature adjustment coefficient t4, and 0<t1<t2<t3<t4<1;
when ΔT>T1, selecting the first preset adjustment coefficient tl to correct the second verification judgment adjustment coefficient Da, and the corrected second verification judgment adjustment coefficient is Da*t1;
when T1≥ΔT>T2, selecting the second preset adjustment coefficient t2 to correct the second verification judgment adjustment coefficient Da, and the corrected second verification judgment adjustment coefficient is Da*t2;
when T2≥ΔT>T3, selecting the third preset adjustment coefficient t3 to correct the second verification judgment adjustment coefficient Da, and the corrected second verification judgment adjustment coefficient is Da*t3;
when T3≥ΔT>T4, selecting the fourth preset adjustment coefficient t4 to correct the second verification judgment adjustment coefficient Da, and the corrected second verification judgment adjustment coefficient is Da*t4.

8. The gear train mechanical operation experimental instrument according to claim 7, wherein the evaluation module selects the i-th preset adjustment coefficient ti to correct the second verification judgment adjustment coefficient Da, where i=1, 2, 3, 4, after obtaining the corrected second verification judgment adjustment coefficient Da*ti, further comprises:
taking the corrected second verification judgment adjustment coefficient Da*ti as the second verification judgment final coefficient Db;
presetting the second verification judgment maximum threshold Dmax;
when Db>Dmax, the evaluation module determines that the second verification judgment result is to correct the secondary judgment result, and the corrected secondary judgment result is not passed, so that the final judgment result is not passed;
when Db≤Dmax, the evaluation module determines that the second verification judgment result is not corrected, so that the secondary judgment result is the final judgment result;
displaying the results based on the final judgment.
